(19) United States
(12) Patent Application Publication
(10) Pub. No.: US 2018/0336141 A1
(43) Pub. Date: Nov. 22, 2018

(54) WORST-CASE MEMORY LATENCY REDUCTION VIA DATA CACHE PRELOADING BASED ON PAGE TABLE ENTRY READ DATA

(71) Applicant: QUALCOMM INCORPORATED, SAN DIEGO, CA (US)

(72) Inventors: KUNAL DESAI, BANGALORE (IN); FELIX VARGHESE, BANGALORE (IN); VASANTHA KUMAR BANDUR PUTTAPPA, BANGALORE (IN)

(21) Appl. No.: 15/596,972

(22) Filed: May 16, 2017

(51) Int. Cl. G06F 12/1045; G06F 12/1009; G06F 12/0862

(52) U.S. Cl. CPC G06F 12/1054; G06F 12/1009; G06F 2212/68; G06F 2212/1024; G06F 2212/602; G06F 12/0862

(57) ABSTRACT

Systems, methods, and computer programs are disclosed for reducing worst-case memory latency in a system comprising a system memory and a cache memory. One embodiment is a method comprising receiving a translation request from a memory client for a translation of a virtual address to a physical address. If the translation is not available at a translation buffer unit and a translation control unit in a system memory management unit, the translation control unit initiates a page table walk. During the page table walk, the method determines a page table entry for an intermediate physical address in the system memory. In response to determining the page table entry for the intermediate physical address, the method preloads data at the intermediate physical address to the system cache before the page table walk for a final physical address corresponding to the intermediate physical address is completed.

### DESCRIPTION OF THE RELATED ART

A system-on-a-chip (SoC) commonly includes one or more processing devices, such as central processing units (CPUs) and cores, as well as one or more memories and one or more interconnects, such as buses. A processing device may issue a data access request to either read data from a system memory or write data to the system memory. For example, in response to a read access request, data is retrieved from the system memory and provided to the requesting device via one or more interconnects. The time delay between issuance of the request and arrival of requested data at the requesting device is commonly referred to as “latency.” Cores and other processing devices compete to access data in system memory and experience varying amounts of latency.

Caching is a technique that may be employed to reduce latency. Data that is predicted to be subject to frequent or high-priority accesses may be stored in a cache memory from which the data may be provided with lower latency than it could be provided from the system memory. As commonly employed caching methods are predictive in nature, an access request may result in a cache hit if the requested data can be retrieved from the cache memory or a cache miss if the requested data cannot be retrieved from the cache memory. If a cache miss occurs, then the data must be retrieved from the system memory instead of the cache memory, at a cost of increased latency. The more requests that can be served from the cache memory instead of the system memory, the faster the system performs overall.

Although caching is commonly employed to reduce latency, caching has the potential to increase latency in instances in which requested data too frequently cannot be retrieved from the cache memory. Display systems are known to be prone to failures due to latency. “Underflow” is a failure that refers to data arriving at the display system too slowly to fill the display in the intended manner.

One known solution that attempts to mitigate the above-described problem in display systems is to increase the sizes of buffer memories in display and camera system cores. This solution comes at the cost of increased chip area. Another known solution that attempts to mitigate the problem is to employ faster memory. This solution comes at costs that include greater chip area and power consumption.

### SUMMARY OF THE DISCLOSURE

Systems, methods, and computer programs are disclosed for reducing worst-case memory latency in a system comprising a system memory and a cache memory. One embodiment is a method comprising receiving a translation request from a memory client for a translation of a virtual address to a physical address. If the translation is not available at a translation buffer unit and a translation control unit in a system memory management unit, the translation control unit initiates a page table walk. During the page table walk, the method determines a page table entry for an intermediate physical address in the system memory. In response to determining the page table entry for the intermediate physical address, the method preloads data at the intermediate physical address to the system cache before the page table walk for a final physical address corresponding to the intermediate physical address is completed.

Another embodiment is a computer system comprising a system memory, a system cache, and a system memory management unit. The system memory management unit comprises a translation buffer unit and a translation control unit. The translation buffer unit is configured to receive a translation request from a memory client for a translation of a virtual address to a physical address. The translation control unit is configured to initiate a page table walk if the translation is not available at the translation buffer unit and the translation control unit. The computer system further comprises control logic for reducing worst-case memory latency in the system. The control logic is configured to: determine a page table entry for an intermediate physical address in the system memory; and in response to determining the page table entry for the intermediate physical address, preload data at the intermediate physical address to the system cache before the page table walk for a final physical address corresponding to the intermediate physical address is completed.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an exemplary memory system illustrating a worst-case latency that may be reduced via data cache preloading based on page table entry read data.

FIG. 2 is a flow chart illustrating an embodiment of a method implemented in the system of FIG. 1 for reducing worst-case memory latency.

FIG. 3 is block/flow diagram illustrating an exemplary embodiment for reducing worst-case memory latency via a data cache preload command initiated by the translation control unit in FIG. 1.

FIG. 4 illustrates an exemplary embodiment of the page table walk of FIG. 3.

FIG. 5 is a block/flow diagram illustrating another embodiment for reducing worst-case memory latency via a page table entry snooper/monitor module in the last level cache.

FIG. 6 illustrates an exemplary embodiment of the page table walk of FIG. 5.

FIG. 7 is a block diagram of an embodiment of a portable computing device that may incorporate the systems and methods for reducing worst-case memory latency.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets (e.g., data from one component interacting with another component in a local system, distributed system, and/or across a network such as the Internet with other systems by way of the signal).

The term “application” or “image” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

The term “task” may include a process, a thread, or any other unit of execution in a device.

The term “virtual memory” refers to the abstraction of the actual physical memory from the application or image that is referencing the memory. A translation or mapping may be used to convert a virtual memory address to a physical memory address. The mapping may be as simple as 1-to-1 (e.g., physical address equals virtual address), moderately complex (e.g., a physical address equals a constant offset from the virtual address), or the mapping may be complex (e.g., every 4 KB page mapped uniquely). The mapping may be static (e.g., performed once at startup), or the mapping may be dynamic (e.g., continuously evolving as memory is allocated and freed).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

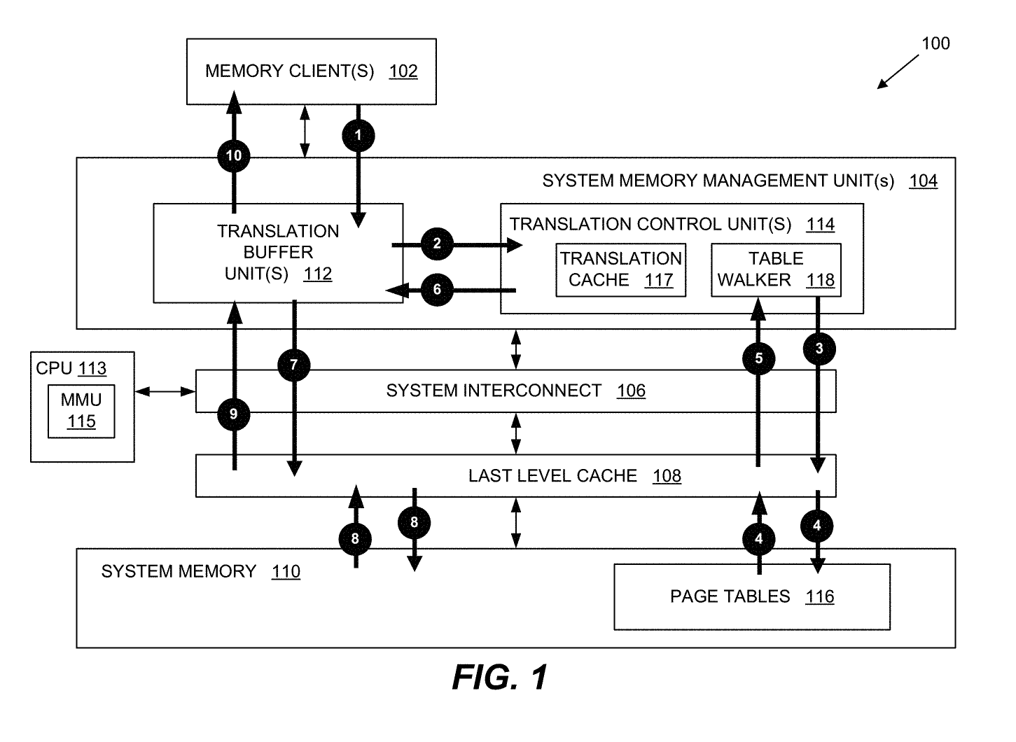

FIG. 1 illustrates an embodiment of a system 100 for reducing a worst-case memory latency. Before describing the worst-case memory latency, the various components and general operation of system 100 will be briefly described. System 100 comprises one or more processing devices, such as memory clients 102 and a central processing unit (CPU) 113. System 100 further includes a system memory 110 and a system cache (e.g., a last level cache 108). System memory 110 may comprise dynamic random access memory (DRAM). A DRAM controller associated with system memory 110 may control accessing system memory 106 in a conventional manner. A system interconnect 106, which may comprise one or more busses and associated logic, interconnects the processing devices, memories, and other elements of computer system 100.

As illustrated in FIG. 1, CPU 113 includes a memory management unit (MMU) 115. MMU 115 comprises logic (e.g., hardware, software, or a combination thereof) that performs address translation for CPU 113. Although for purposes of clarity MMU 115 is depicted in FIG. 1 as being included in CPU 113, MMU 115 may be externally coupled to CPU 113. Computing system 100 also includes one or more system memory management units (SMMUs) 104 electrically coupled to memory clients 102. An SMMU 104 provides address translation services for upstream device traffic in much the same way that a processor's MMU, such as MMU 115, translates addresses for processor memory accesses.

An SMMU 104 comprises a translation buffer unit (TBU) 112 and a translation control unit (TCU) 114. TBU 112 stores recent translations of virtual memory to physical memory in, for example, a translation look-aside buffer (TLB). If a virtual-to-physical address translation is not available in TBU 112, TCU 114 may perform a page table walk executed by a page table walker module 118. In this regard, the main functions of TCU 114 include address translation, memory protection, and attribute control. Address translation is a method by which an input address in a virtual address space is translated to an output address in a physical address space. Translation information is stored in page tables 116 that SMMU 104 references to perform address translation. There are two main benefits of address translation. First, address translation allows memory clients 102 to address a large physical address space. For example, a 32 bit processing device (i.e., a device capable of referencing 2³² address locations) can have its addresses translated such that memory client 102 may reference a larger address space, such as a 36 bit address space or a 40 bit address space. Second, address translation allows processing devices to have a contiguous view of buffers allocated in memory, despite the fact that memory buffers are typically fragmented, physically non-contiguous, and scattered across the physical memory space.

Page tables 116 contains information necessary to perform address translation for a range of input addresses. Although not shown in FIG. 1 for purposes of clarity, page tables 116 may include a plurality of tables comprising page table entries (PTE). It should be appreciated that the page tables 116 may include a set of sub-tables arranged in a multi-level “tree” structure. Each sub-table may be indexed with a sub-segment of the input address. Each sub-table may include translation table descriptors. There are three base types of descriptors: (1) an invalid descriptor, which contains no valid information; (2) table descriptors, which contain a base address to the next level sub-table and may contain translation information (such as access permission) that is relevant to all sub-sequent descriptors encountered during the walk; and (3) block descriptors, which contain a base output address that is used to compute the final output address and attributes/permissions relating to block descriptors.

The process of traversing page tables 116 to perform address translation is known as a “page table walk.” A page table walk is accomplished by using a sub-segment of an input address to index into the translation sub-table, and finding the next address until a block descriptor is encountered. A page table walk comprises one or more “steps.” Each “step” of a page table walk involves: (1) an access to a page table 116, which includes reading (and potentially updating) it; and (2) updating the translation state, which includes (but is not limited to) computing the next address to be referenced. Each step depends on the results from the previous step of the walk. For the first step, the address of the first page table entry that is accessed is a function of the translation table base address and a portion of the input address to be translated. For each subsequent step, the address of the page table entry accessed is a function of the page table entry from the previous step and a portion of the input address.

Having generally described the components of computing system 100, various embodiments of systems and methods for reducing a worst-case memory latency will now be described. It should be appreciated that, in the computing system 100, a worst-case memory latency refers to the situation in which address translation results in successive “misses” by TBU 112, TCU 114, and last level cache 108 (i.e., a TBU/TCU/LLC miss). An exemplary embodiment of a TBU/TCU/LLC miss is illustrated by steps 1-10 in FIG. 1.

In step 1, a memory client 102 requests translation of a virtual address. Memory client 102 may send a request identifying a virtual address to TBU 112. If a translation is not available in the TLB, TBU 112 sends the virtual address to TCU 114 (step 2). TCU 114 may access a translation cache 117 and, if a translation is not available, may perform a page table walk comprising a number of table walks (steps 3, 4, and 5) to get a final physical address in the system memory 110. It should be appreciated that some intermediate table walks may already be stored in translation cache 117. Steps 3, 4, and 5 are repeated for all translations that TCU 114 does not have available in translation cache 117. The worst-case memory latency occurs when steps 3, 4, and 5 go to last level cache 108/system memory 110 for a next page table entry. At step 6, TCU 114 may send the final physical address to TBU 112. Step 7 involves TBU 112 requesting the read-data at the final physical address which it received from TCU 114. Steps 8 and 9 involve getting the read-data at the final physical address to TBU 112. Step 10 involves TBU 112 returning the read-data from the physical address back to the requesting memory client 102. Table 1 below illustrates an approximate structural latency, representing a worst-case memory latency scenario, for each of the steps illustrated in the embodiment of FIG. 1.

TABLE 1

| | Approximate Structural Latency |
|---|---|
| Step No. | (ns) |
| 1 | 10 |
| 2 | 20 |
| 3 | 20 |
| 4 | 100 |
| 5 | 20 |
| 6 | 20 |
| 7 | 20 |
| 8 | 100 |
| 9 | 20 |
| 10 | 10 |

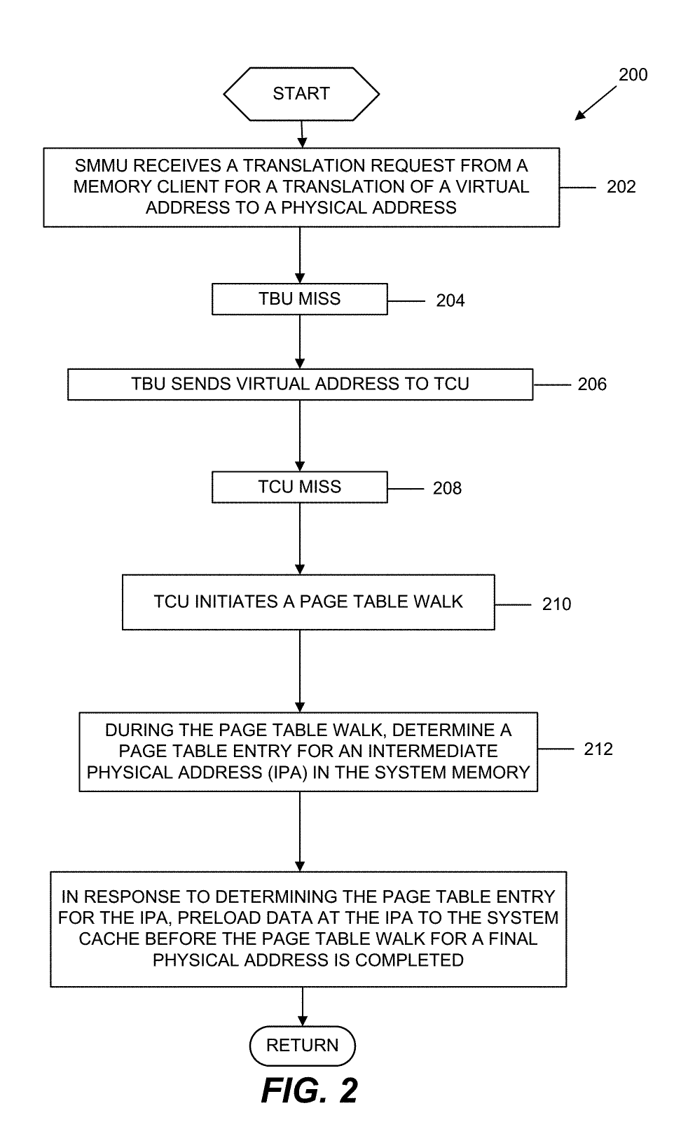

FIG. 2 illustrates an embodiment of a method for reducing worst-case memory latency in the computer system of FIG. 1. At block 202, SMMU 104 receives a request from a memory client 102 for a translation of a virtual address to a physical address. The request may be received by TBU 112. At block 204, a TBU miss occurs if a translation is not available in, for example, a TLB. At block 206, TBU 112 sends the requested virtual address to TCU 114. At block 208, a TCU miss occurs if a translation is not available in translation cache 117. At block 210, TCU 114 initiates a page table walk via, for example, page table walker module 118. During the page table walk, at block 212, a page table entry for an intermediate physical address in the system memory 110 may be determined. In response to determining the page table entry for the intermediate physical address, at block 214, the data at the determined intermediate physical address may be preloaded to the last level cache 108 before the page table walk for a final physical address is completed.

As described below in more detail, the page table walk may comprise two stages. A first stage may determine the intermediate physical address. A second stage may involve resolving data access permissions at the end of which the physical address is determined. After obtaining the intermediate physical address during the first stage, TCU 114 may not be able to send the intermediate physical address to TBU 112 until access permissions are cleared by TCU 114 based on subsequent table walks. Although the intermediate physical address may not be sent to TBU 112 until the second stage is completed, the method 200 enables the data at the intermediate physical address to be preloaded into last level cache 108 before the second stage is completed. When TBU 112 does get the final physical address after all access permission checking page table walks have completed, the data at the final physical address will be available in last level cache 108 instead of having to go to system memory 110. In this manner, the method 200 may eliminate the structural latency associated with step 8 (FIG. 1 and Table 1).

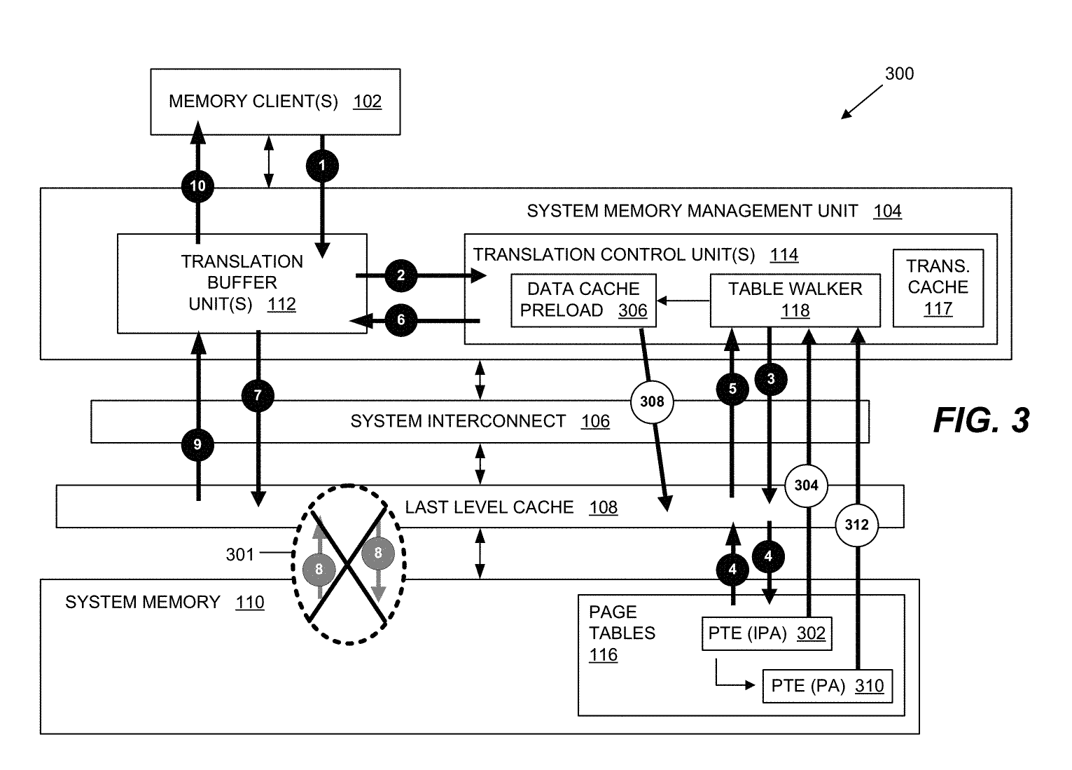

FIG. 3 is block/flow diagram illustrating an exemplary embodiment for reducing worst-case memory latency via a data cache preload command initiated by TCU 114. During the page table walk illustrated in steps 3, 4, and 5, TCU 114 may receive the page table entry read-data. When a next page table entry for an intermediate physical address hits the system memory 110 (i.e., PTE 302), the read-data may be determined by TCU 114 at reference numeral 304. In response, TCU 114 may generate and send the data cache preload command 306 to last level cache 108 (reference numeral 308). As mentioned above, the data cache preload command 306 may be configured to preload the data at the intermediate physical address associated with PTE 302 before the subsequent page table walk for the final physical address (i.e., PTE 310) is completed. At reference numeral 312, the final physical address for PTE 310 may be received at TCU 114. At step 6, TCU 114 may send the final physical address to TBU 112. Step 7 involves TBU 112 requesting the read-data at the final physical address which it received from TCU 114. Because the data at the final physical address has been preloaded into last level cache 108, step 8 of going to system memory 110 may be eliminated (reference numeral 301), which may significantly reduce the overall memory latency in a TBU/TCU/LLC miss scenario.

In some embodiments, TBU 112 may be configured to provide page offset information or other “hints” to TCU 114. Where a lowest page granule size comprises, for example, 4 KB, the TCU 114 may fetch page descriptors without processing the lower 12 bits of an address. It should be appreciated that, for the last level cache 108 to perform a prefetch, the TBU 112 may pass on a bit range (11:6) of the address to TCU 114. It should be further appreciated that the bit range (5:0) of the address is not required as the cache line size in the last level cache 108 may comprise 64 B. In this regard, the page offset information or other “hint) may originate from the memory clients 102 or the TBU 112. In either case, the TBU 112 will pass on the hint to the TCU 114, which may comprise information such as a page offset and a pre-load size.

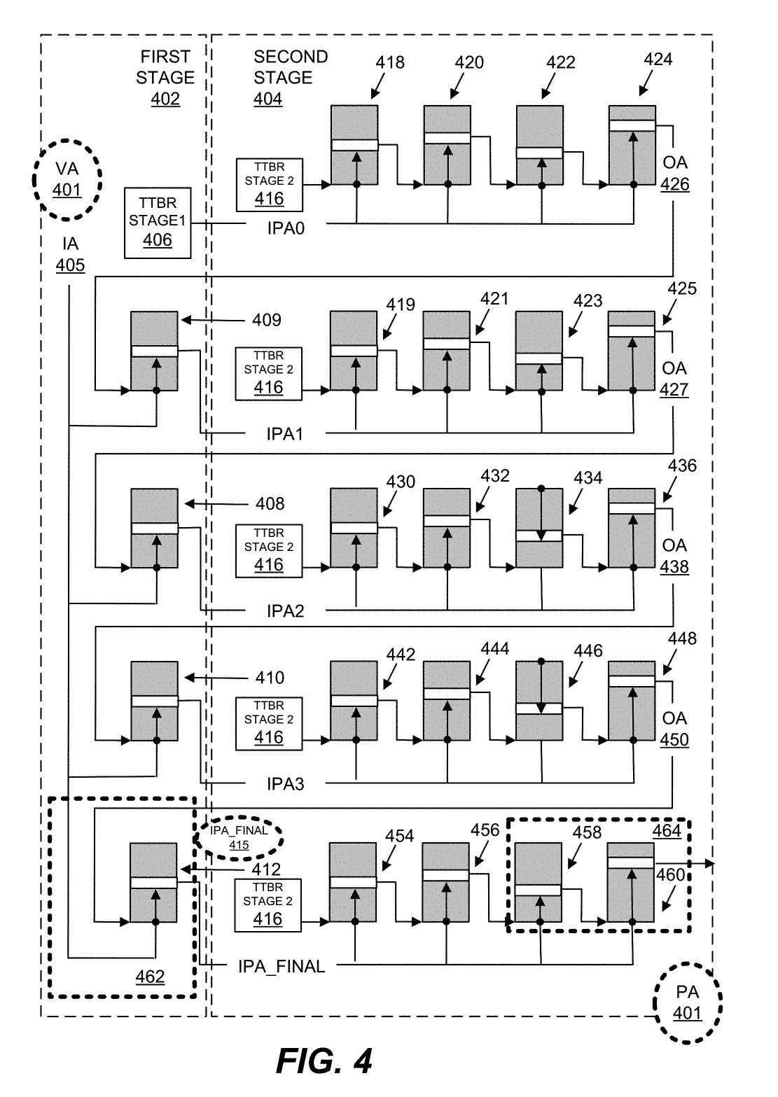

FIG. 4 illustrates an exemplary embodiment of a page table walk for system 300 of FIG. 3. The page table walk translates a virtual address 401 requested by a memory client 102 to a physical address 404 located in system memory 110. The page table walk comprises a first stage 402 and a second stage 404. The first stage 402 determines intermediate physical addresses, and the second stage 404 involves resolving data access permissions at the end of which a physical address is determined. The page tables associated with the first stage 402 may be programmed by an operating system in a main memory and indexed with an intermediate physical address that is to be translated to a physical address. The page tables associated with the second stage 404 may be controlled by secure software or a virtual machine monitor (e.g., Hypervisor) indexed with the physical addresses. It should be appreciated that each row illustrated in the page table walk of FIG. 4 comprises a sequence of main memory access for the a page table fetched performed in the first stage 402 followed by the page walks in the second stage 404.

As illustrated in FIG. 4, the first row illustrates translation of an intermediate physical address from the first stage translation table base register (TTBR_STAGE1 406) through a sequence of second stage page table walks 418, 420, 422, and 424. The input address from TTBR_STAGE 1 406 is denoted as IPA0. For a first memory access (reference numeral 418), a second stage TTBR (TTBR_STAGE2 416) is the base address and the offset may comprise a predetermined number of bits, for example, 9-bits from IPA0[47:39]. Data content from this table descriptor may form the base address for the next fetch (reference numeral 420) while IPA0[38:30] is the offset. It should be appreciated that this sequence may be repeated for a fetch 422 with an offset of IPA0[29:21] and a fetch 424 with an offset of IA[20:12]. Data read from the fetch 424 comprises the physical address corresponding to TTBR_STAGE1 406 and forms a base address for the first stage fetch 408 in the second row.

It should be appreciated that the subsequent rows in FIG. 4 may follow a similar process. In the second row of FIG. 1, the input address (IA[47:39]) may be used as an offset for a first stage fetch.

The third row in FIG. 4 illustrates a sequence of first level page table (e.g., GB level) walks comprising a first stage fetch 408 and subsequent translation of an intermediate physical address (IPA2) to a corresponding physical address 438. The page walk may provisionally end at reference numeral 438 if the descriptor read at fetch 408 is marked as a block of granule 1 GB. An input address IA[38:30] may used as an offset for the first stage fetch 408.

The fourth row in FIG. 4 illustrates a sequence of second level page table (e.g., MB level) walks comprising a first stage fetch 410 and subsequent translation of an intermediate physical address (IPA3) to a corresponding physical address 450. The page walk may provisionally end at reference numeral 450 if the descriptor read at fetch 410 is marked as a block of granule 2 MB. An input address IA[29:21] may be used as an offset for the first stage fetch 410.

The fifth row in FIG. 4 illustrates a sequence of third and final level page table (e.g., KB level) walks comprising a first stage fetch 412 and subsequent translation of an intermediate physical address (IPA4) to a corresponding final physical address 404. the page walk ends at reference numeral 404 as the descriptor read is a leaf-level granule of 4 KB page. An input address IA[20:12] may used as an offset for the first stage fetch 412.

It should be appreciated that the last row in the page table walk represents stage 1 and stage 2 page tables associated with the system memory 110. In this regard, the previous rows illustrate that the page table walk resulted in a TCU miss and a last level cache miss. At reference numeral 462 in the page table walk, TCU 114 may determine the intermediate physical address (IPA) 415. In response, TCU 114 may generate the data cache preload command 306 (FIG. 3). Because the IPA 415 is understood to be the same as the physical address 404, the data preloaded to last level cache 108 will be the same data at the final physical address.

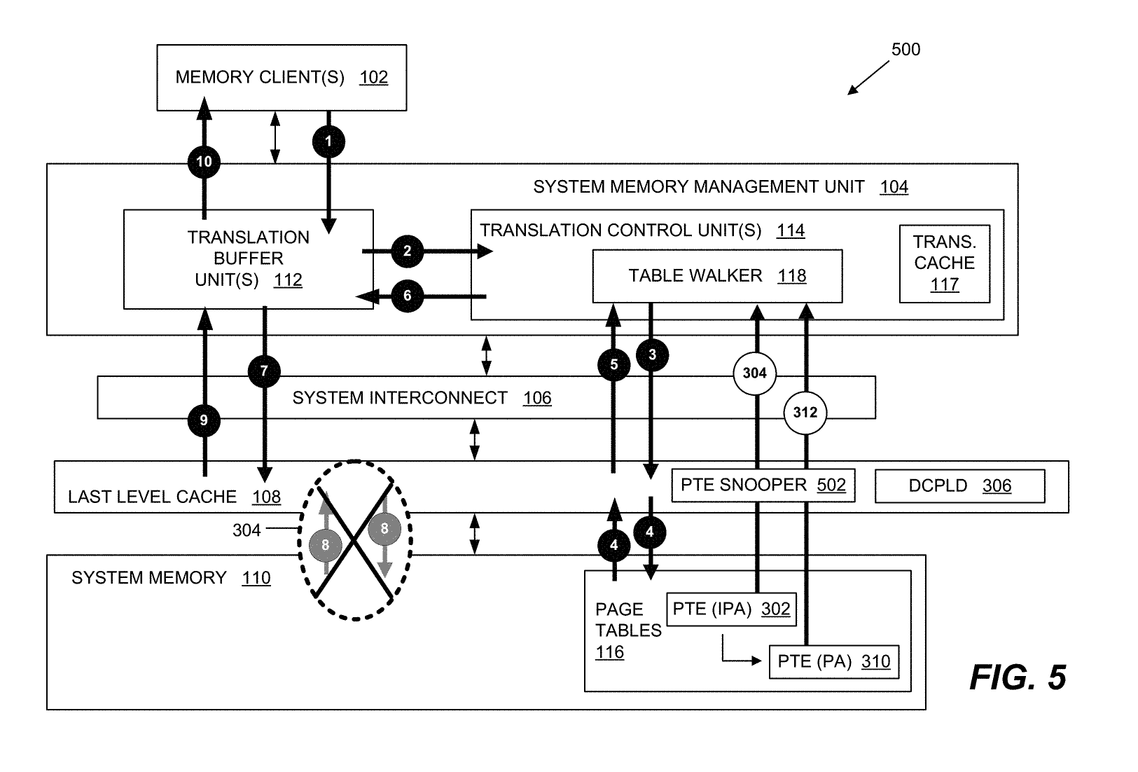

FIG. 5 is block/flow diagram illustrating an another embodiment in which the data cache preload command is initiated within the last level cache 108. In this embodiment, the last level cache 108 comprises a PTE snooper/monitor module 502 used to generate the data cache preload command 306. As illustrated in FIG. 5, PTE snooper/monitor module 502 monitors (or “snoops”/reviews) the PTE read-data between TCU 114 and the system memory 110 to determine when a last level cache miss has occurred and, therefore, a next page table entry hits the system memory 110. The unique ID of all page table walk transactions for which a prefetch is desired may be stored by the PTE snooper/monitor module 502. The read data stream coming from the system memory 110 may also bear this unique ID information. The PTE snooper module 502 may compare these unique IDs with the incoming read data to determine which original table walk transaction read data it is. The unique IDs stored in the PTE snooper module 502 may be extracted from the page table walk transaction coming from the TCU 114 to the last level cache 108.

The PTE snooper module 502 may then use the page descriptor information captured from the PTE read data to initiate a prefetch to the system memory 110. The offset provided by the TCU 114 to the last level cache 108 may be added to the page address captured through the PTE read data to calculate the final system memory address for which the prefetch needs to be initiated. The offset may be 12 bits as page size is 4 KB in granularity. For the TCU 114 initiated prefetch, the offset may be only 6 bits wide (e.g., bits[11:6]) as addresses may be cache-line aligned (64 Bytes).

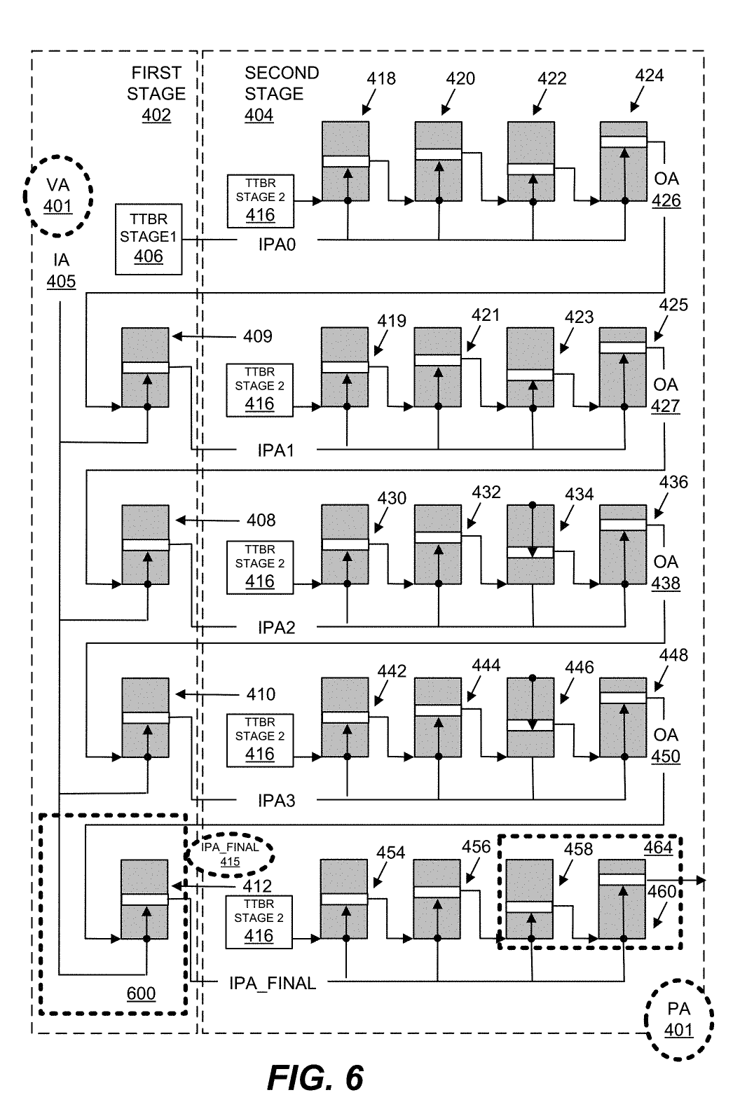

FIG. 6 illustrates an exemplary embodiment of the page table walk for the implementation in FIG. 5. It should be appreciated that the page table walk sequence illustrated in FIG. 6 is generally similar to FIG. 4. However, in this embodiment, as illustrated at reference numeral 600, the page descriptor read operation for the final intermediate physical address 415 from the TCU 144 may comprise flag and/or offset hints. These hints may signal to the PTE snooper/monitor 502 to initiate a last level cache prefetch. The last level cache prefetch may be done on the final IPA 415 returned to the TCU 114. In this regard, an additional data preload command may not be required in the scheme associated with FIGS. 5 and 6.

Having described the page table walk sequences associated with the embodiments of FIGS. 4 and 6, one of ordinary skill in the art will readily appreciate that the final physical address is equal to the intermediate physical address with the final second stage page table walk being used only to fetch additional access control attributes regarding the final physical address being accessed and may not be required for actual virtual to physical address translation. In other embodiments, the final physical address may be equal to the intermediate physical address resulting in early preloading of data at the intermediate physical address to the system cache 108 before the final second stage page table walk for the access control attributes for the final physical address corresponding to the intermediate physical address is completed. In further embodiments, the final physical address may be a function of the intermediate physical address (e.g., equal, addition, subtraction, multiplication, division) with a known constant value resulting in early preloading of data at the intermediate physical address to the system cache 108 before the final second stage page table walks for access control attributes for the final physical address corresponding to the intermediate physical address are completed.

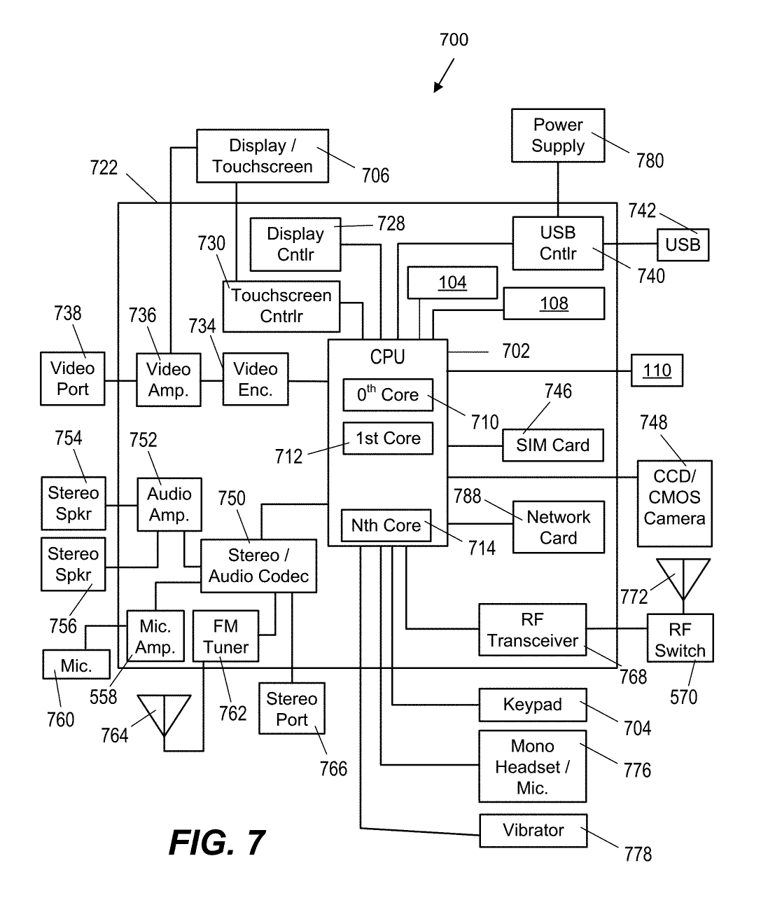

FIG. 7 illustrates an embodiment in which one or more components of the system 100 are incorporated in an exemplary portable computing device (PCD) 700. PCD 700 may comprise a smart phone, a tablet computer, or a wearable device (e.g., a smart watch, a fitness device, etc.). It will be readily appreciated that certain components of the system 100 are included on the SoC 722 (e.g., SMMU 104, last level cache 108) while other components (e.g., the system memory 110) are external components coupled to the SoC 722. The SoC 722 may include a multicore CPU 702. The multicore CPU 702 may include a zeroth core 710, a first core 712, and an Nth core 714. One of the cores may comprise, for example, a graphics processing unit (GPU) with one or more of the others comprising the CPU.

A display controller 728 and a touch screen controller 730 may be coupled to the CPU 702. In turn, the touch screen display 707 external to the on-chip system 722 may be coupled to the display controller 728 and the touch screen controller 730.

FIG. 7 further shows that a video encoder 734, e.g., a phase alternating line (PAL) encoder, a sequential color a memoire (SECAM) encoder, or a national television system(s) committee (NTSC) encoder, is coupled to the multicore CPU 702. Further, a video amplifier 736 is coupled to the video encoder 734 and the touch screen display 706. Also, a video port 738 is coupled to the video amplifier 736. As shown in FIG. 7, a universal serial bus (USB) controller 740 is coupled to the multicore CPU 702. Also, a USB port 742 is coupled to the USB controller 740. Memory 108 and 110 and a subscriber identity module (SIM) card 746 may also be coupled to the multicore CPU 702.

Further, as shown in FIG. 7, a digital camera 748 may be coupled to the multicore CPU 702. In an exemplary aspect, the digital camera 748 is a charge-coupled device (CCD) camera or a complementary metal-oxide semiconductor (CMOS) camera.

As further illustrated in FIG. 7, a stereo audio coder-decoder (CODEC) 750 may be coupled to the multicore CPU 702. Moreover, an audio amplifier 752 may be coupled to the stereo audio CODEC 750. In an exemplary aspect, a first stereo speaker 754 and a second stereo speaker 756 are coupled to the audio amplifier 752. FIG. 7 shows that a microphone amplifier 758 may be also coupled to the stereo audio CODEC 750. Additionally, a microphone 760 may be coupled to the microphone amplifier 758. In a particular aspect, a frequency modulation (FM) radio tuner 762 may be coupled to the stereo audio CODEC 750. Also, an FM antenna 764 is coupled to the FM radio tuner 762. Further, stereo headphones 766 may be coupled to the stereo audio CODEC 750.

FIG. 7 further illustrates that a radio frequency (RF) transceiver 768 may be coupled to the multicore CPU 702. An RF switch 770 may be coupled to the RF transceiver 768 and an RF antenna 772. A keypad 704 may be coupled to the multicore CPU 702. Also, a mono headset with a microphone 776 may be coupled to the multicore CPU 702. Further, a vibrator device 778 may be coupled to the multicore CPU 702.

FIG. 7 also shows that a power supply 780 may be coupled to the on-chip system 722. In a particular aspect, the power supply 780 is a direct current (DC) power supply that provides power to the various components of the PCD 700 that require power. Further, in a particular aspect, the power supply is a rechargeable DC battery or a DC power supply that is derived from an alternating current (AC) to DC transformer that is connected to an AC power source.

FIG. 7 further indicates that the PCD 700 may also include a network card 788 that may be used to access a data network, e.g., a local area network, a personal area network, or any other network. The network card 788 may be a Bluetooth network card, a WiFi network card, a personal area network (PAN) card, a personal area network ultra-low-power technology (PeANUT) network card, a television/cable/satellite tuner, or any other network card well known in the art. Further, the network card 788 may be incorporated into a chip, i.e., the network card 788 may be a full solution in a chip, and may not be a separate network card 788.

As depicted in FIG. 7, the touch screen display 706, the video port 738, the USB port 742, the camera 748, the first stereo speaker 754, the second stereo speaker 756, the microphone 760, the FM antenna 764, the stereo headphones 766, the RF switch 770, the RF antenna 772, the keypad 774, the mono headset 776, the vibrator 778, and the power supply 780 may be external to the on-chip system 722.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for reducing worst-case memory latency in a system comprising a system memory management unit, a system memory, and a cache memory, the method comprising:
receiving a translation request from a memory client for a translation of a virtual address to a physical address;
if the translation is not available at a translation buffer unit and a translation control unit in a system memory management unit, the translation control unit initiating a page table walk;
during the page table walk, determining a page table entry for an intermediate physical address in the system memory; and
in response to determining the page table entry for the intermediate physical address, preloading data at the intermediate physical address to the system cache before the page table walk for a final physical address corresponding to the intermediate physical address is completed.

2. The method of claim 1, wherein the determining the page table entry for the intermediate physical address involves the translation control unit, and the preloading the data at the intermediate physical address to the system cache comprises:
the translation control unit sending a data cache preload command to the system cache;
the translation control unit sending the final physical address to the translation buffer unit; and
the translation buffer unit reading the preloaded data from the system cache.

3. The method of claim 1, wherein the page table entry for the intermediate physical address is determined by the system cache, the system cache preloads the data at the intermediate physical address, and the determining the page table entry for the intermediate physical address comprises the system cache snooping page table entry data.

4. The method of claim 1, wherein the final physical address is equal to the intermediate physical address, and a second stage page table walk is performed to determine the final physical address in order to fetch one or more access control attributes.

5. The method of claim 1, wherein the final physical address is equal to the intermediate physical address, and wherein the preloading of the data at the intermediate physical address to the system cache occurs before a final second stage page table walk is completed to determine one or more access control attributes for the final physical address corresponding to the intermediate physical address.

6. The method of claim 1, wherein the final physical address comprises a function of the intermediate physical address, and wherein the preloading of the data at the intermediate physical address to the system cache occurs before a final second stage page table walk is completed to determine one or more access control attributes for the final physical address corresponding to the intermediate physical address.

7. The method of claim 1, wherein the translation buffer unit provides one or more hints to the translation control unit related to a page offset or a preload size.

8. A system for reducing worst-case memory latency in a system comprising a system memory and a cache memory, the system comprising:
means for receiving a translation request from a memory client for a translation of a virtual address to a physical address;
means for initiating a page table walk;
means for determining a page table entry for an intermediate physical address in the system memory during the page table walk; and
means for preloading data at the intermediate physical address to the system cache before the page table walk for a final physical address corresponding to the intermediate physical address is completed.

9. The system of claim 8, wherein the means for determining the page table entry for the intermediate physical address comprises a translation control unit in a system memory management unit.

10. The system of claim 9, wherein the means for preloading the data at the intermediate physical address to the system cache comprises:
means for sending a data cache preload command to the system cache.

11. The system of claim 10, further comprising:
means for sending the final physical address to a translation buffer unit; and
means for reading the preloaded data from the system cache.

12. The system of claim 8, wherein the means for determining the page table entry for the intermediate physical address comprises the system cache and a means for snooping page table entry data in the system cache, and wherein the system cache preloads the data at the intermediate physical address.

13. The system of claim 8, wherein the final physical address is equal to the intermediate physical address, and the method further comprises:
a means for fetching one or more access control attributes during a second stage page table walk to determine the final physical address.

14. The system of claim 8, wherein the final physical address is equal to the intermediate physical address, and wherein the means for preloading the data at the intermediate physical address to the system cache occurs before a final second stage page table walk is completed to determine one or more access control attributes for the final physical address corresponding to the intermediate physical address.

15. A computer program embodied in a non-transitory computer-readable medium and executable by a processing device, the computer program for reducing worst-case memory latency in a system comprising a system memory and a cache memory, the computer program comprising logic configured to:
receive a translation request from a memory client for a translation of a virtual address to a physical address;
if the translation is not available at a translation buffer unit and a translation control unit in a system memory management unit, initiate a page table walk;
during the page table walk, determine a page table entry for an intermediate physical address in the system memory; and
in response to determining the page table entry for the intermediate physical address, preload data at the intermediate physical address to the system cache before the page table walk for a final physical address corresponding to the intermediate physical address is completed.

16. The computer program of claim 15, wherein the logic configured to determine the page table entry for the intermediate physical address involves a translation control unit, and wherein the logic configured to preload the data at the intermediate physical address to the system cache comprises logic configured to:
send a data cache preload command to the system cache;
send the final physical address to a translation buffer unit; and
read the preloaded data from the system cache.

17. The computer program of claim 15, wherein the page table entry for the intermediate physical address is determined by the system cache, and the system cache preloads the data at the intermediate physical address.

18. The computer program of claim 17, wherein the logic configured to determine the page table entry for the intermediate physical address comprises logic configured to:
snoop page table entry data in the system cache.

19. The computer program of claim 15, wherein the final physical address is equal to the intermediate physical address, and a second stage page table walk is performed to determine the final physical address in order to fetch one or more access control attributes.

20. The computer program of claim 15, wherein the final physical address is equal to the intermediate physical address, and wherein the logic configured to preload the data at the intermediate physical address to the system cache occurs before a final second stage page table walk is completed to determine one or more access control attributes for the final physical address corresponding to the intermediate physical address.

21. The computer program of claim 15, wherein the final physical address comprises a function of the intermediate physical address, and wherein the preloading of the data at the intermediate physical address to the system cache occurs before a final second stage page table walk is completed to determine one or more access control attributes for the final physical address corresponding to the intermediate physical address.

22. A computer system comprising:
a system memory;
a system cache;
a system memory management unit comprising a translation buffer unit and a translation control unit, the translation buffer unit configured to receive a translation request from a memory client for a translation of a virtual address to a physical address, the translation control unit configured to initiate a page table walk if the translation is not available at the translation buffer unit and the translation control unit; and
control logic for reducing worst-case memory latency in the system, the control logic configured to: determine a page table entry for an intermediate physical address in the system memory; and in response to determining the page table entry for the intermediate physical address, preload data at the intermediate physical address to the system cache before the page table walk for a final physical address corresponding to the intermediate physical address is completed.

23. The computer system of claim 22, wherein the determining the page table entry for the intermediate physical address involves the translation control unit, and the preloading the data at the intermediate physical address to the system cache comprises:
the translation control unit sending a data cache preload command to the system cache;
the translation control unit sending the final physical address to the translation buffer unit; and
the translation buffer unit reading the preloaded data from the system cache.

24. The computer system of claim 22, wherein the page table entry for the intermediate physical address is determined by the system cache, and wherein the system cache preloads the data at the intermediate physical address and determines the page table entry for the intermediate physical address by snooping page table entry data.

25. The computer system of claim 22, wherein the system memory comprises dynamic random access memory (DRAM).

26. The computer system of claim 22 incorporated in a portable computing device.

27. The computer system of claim 22, wherein the final physical address is equal to the intermediate physical address, and a second stage page table walk is performed to determine the final physical address in order to fetch one or more access control attributes.

28. The computer system of claim 22, wherein the final physical address is equal to the intermediate physical address, and wherein the preloading of the data at the intermediate physical address to the system cache occurs before a final second stage page table walk is completed to determine one or more access control attributes for the final physical address corresponding to the intermediate physical address.

29. The computer system of claim 22, wherein the final physical address comprises a function of the intermediate physical address, and wherein the preloading of the data at the intermediate physical address to the system cache occurs before a final second stage page table walk is completed to determine one or more access control attributes for the final physical address corresponding to the intermediate physical address.

30. The computer system of claim 22, wherein the translation buffer unit provides one or more hints to the translation control unit related to a page offset or a preload size.
